(19) United States
(12) Patent Application Publication
(10) Pub. No.: US 2022/0107188 A1
(43) Pub. Date: Apr. 7, 2022

(54) INFORMATION PROCESSING DEVICE, INFORMATION PROCESSING METHOD, AND PROGRAM

(71) Applicant: TOYOTA JIDOSHA KABUSHIKI KAISHA, Toyota-shi (JP)

(72) Inventor: Naoya OKA, Nagakute-shi (JP)

(73) Assignee: TOYOTA JIDOSHA KABUSHIKI KAISHA, Toyota-shi (JP)

(21) Appl. No.: 17/356,654

(22) Filed: Jun. 24, 2021

(30) Foreign Application Priority Data
Oct. 7, 2020 (JP) 2020-169579

(51) Int. Cl. G01C 21/34; G06Q 10/02; G08G 1/123; G06Q 30/02

(52) U.S. Cl. CPC G01C 21/3438; G06Q 30/0224; G08G 1/123; G06Q 10/02

(57) ABSTRACT

An information processing device that manages a plurality of vehicles includes a controller configured to execute operations including specifying a first user estimated to start moving within a predetermined period of time from among a plurality of users based on a result of sensing the users and generating a schedule for dispatching a vehicle under management to the first user. The controller is configured to execute a predetermined process for resolving a shortage of the vehicles when the number of vehicles under the management is insufficient as a result of assigning the vehicles to a plurality of the first users.

### CROSS-REFERENCE TO RELATED APPLICATION

This application claims priority to Japanese Patent Application No. 2020-169579 filed on Oct. 7, 2020, incorporated herein by reference in its entirety.

### BACKGROUND

### 1. Technical Field

The disclosure relates to a technique for supporting movement of users.

### 2. Description of Related Art

In the future, it is expected that a service is to be built for supporting movement of users by dispatching autonomous vehicles to the users. For example, Japanese Unexamined Patent Application Publication No. 2019-101464 (JP 2019-101464 A) discloses a system for allocating a vehicle capable of unmanned driving to a designated place in a timely manner.

### SUMMARY

On the other hand, the number of vehicles under the management of the system is limited, and thus when many users need vehicles at the same time, it may not be possible to allocate the vehicles to all users.

An object of the disclosure is to generate an appropriate vehicle allocation schedule in a system for autonomously dispatching a vehicle to a user.

A first aspect of the present disclosure relates to an information processing device that manages a plurality of vehicles. The information processing device includes a controller configured to execute operations comprising specifying a first user estimated to start moving within a predetermined period of time from among a plurality of users based on a result of sensing the users and generating a schedule for dispatching a vehicle under management to the first user. The controller is configured to execute a predetermined process for resolving a shortage of the vehicles when the number of vehicles under the management is insufficient as a result of assigning the vehicles to a plurality of the first users.

A second aspect of the present disclosure relates to an information processing method that is executed by an information processing device that manages a plurality of vehicles. The information processing method includes specifying a first user estimated to start moving within a predetermined period of time from among a plurality of users based on a result of sensing the users, generating a schedule for dispatching a vehicle under management to the first user, and executing a predetermined process for resolving a shortage of the vehicles under the management when there is the shortage of the vehicles as a result of assigning the vehicles to a plurality of the first users.

Other aspects of the disclosure relate to a program that causes a computer to execute the information processing method according to the second aspect and a computer-readable storage medium that non-transitorily stores the program.

According to the aspects of the disclosure, it is possible to generate an appropriate vehicle allocation schedule in a system that autonomously dispatches vehicles to users.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a vehicle allocation system;

FIG. 2 is a block diagram illustrating components of the vehicle allocation system in more detail;

FIG. 3 is an example of terminal position data stored in a storage unit;

FIG. 4A is an example of a behavior model stored in the storage unit;

FIG. 4B is an example of a behavior model stored in the storage unit;

FIG. 5 is an example of vehicle data stored in the storage unit;

FIG. 6 is a data flow diagram between functional modules included in a controller;

FIG. 7 is a diagram illustrating a vehicle allocation waiting queue;

FIG. 8 is a flowchart of a process executed by the controller in a first embodiment;

FIG. 9 is a flowchart of a process executed by the controller in the first embodiment;

FIG. 10 is a flowchart of a process executed by the controller in the first embodiment; and

FIG. 11 is a flowchart of a process executed by a controller in a second embodiment.

### DETAILED DESCRIPTION OF EMBODIMENTS

In the near future, it is expected that a system is to be constructed for supporting movement of users by autonomous travelling vehicles operated on demand.
Further, it is expected that a technology is to be put into practical use for autonomously allocating a vehicle by detecting that a user needs means of transportation before the user expresses his or her intention.

In the system as described above, there is a possibility demand may be concentrated. For example, when a large number of users needs something to ride for movement in a short period of time in an area, a case where the system cannot provide vehicles due to a shortage of vehicles may occur.
In order to handle the case, the information processing device according to the present embodiment takes measures to resolve the shortage of vehicles when the shortage is expected.

According to an embodiment, an information processing device that manages a plurality of vehicles includes a controller configured to specify a first user estimated to start moving within a predetermined period of time from among a plurality of users based on a result of sensing the users and generate a schedule for dispatching a vehicle under management to the first user, in which the controller is configured to execute a predetermined process for resolving a shortage of the vehicles when the number of vehicles under the management is insufficient as a result of assigning the vehicles to a plurality of the first users.

The information processing device estimates that the user will start moving (for example, start returning home from outside) in the near future based on the result of sensing the user. Any content of the sensing may be used as long as it relates to the behavior taken by the user. For example, by sensing position information of the user, it can be estimated that the user is going to return home from outside. In this way, the controller autonomously determines that the vehicle is to be dispatched to the user.

Further, when there are not enough vehicles assigned to the first user, the controller executes a predetermined process for resolving the shortage of vehicles. The predetermined process may be, for example, a process for canceling the assignment of the vehicle to a user having a low priority, or a process for adjusting the vehicle allocation schedule itself.
When there is the shortage of vehicles in the assignment of vehicles, the process for resolving the shortage in advance is executed, which makes it possible to smoothly provide the transportation service.

The controller may execute a first process for changing a start time of movement for at least one of the first users when the shortage of the vehicles is resolved by changing the start time of movement for the first user, as the predetermined process.
Furthermore, the controller may execute a first process for delaying a start of movement by a predetermined time for at least one of the first users when the shortage of the vehicles is resolved by delaying the start of movement by the predetermined time for the first user, as the predetermined process.

When the user can tolerate changing (for example, delaying) the start time of movement, the shortage of vehicles can be resolved by changing a vehicle allocation time of the vehicle with consent of the user.

Furthermore, the controller may delay the start of movement by giving the first user staying in a commercial facility an incentive possible to be used at a store to allow the first user to use the store.
When the first user is staying in the commercial facility, a method of delaying the start of returning home can be taken by giving the user an incentive. For example, by giving a coupon or the like possible used at a specific store (for a specific product or service) to the user, the use of the store can be promoted.

Furthermore, the controller may be configured to decide the store based on a preference of the first user.
By giving an incentive corresponding to the product or service preferred by the first user, the use of the store can be promoted. The preference of the first user may be determined by referring to a profile or the like of the user, or may be determined based on a behavior history or the like of the user.

Furthermore, the controller may execute a second process for providing alternative means of transportation to at least one of the first users as the predetermined process.

When the first user can tolerate the use of the alternative means of transportation, it is possible to resolve the shortage of the vehicles by using the alternative means of transportation. The second process may be a process for providing the means of transportation itself, or may be a process for bearing transportation costs (for example, the fare of public transportation).

The controller may decide whether to execute a first process for delaying a start of movement by a predetermined time or to execute a second process for providing alternative means of transportation, for each of the first users, based on a preference of the first user, as the predetermined process.
For example, determination may be made as to whether the vehicle is desired to be allocated even if the start time of movement is changed, or whether the movement is desired to be made as scheduled by other means of transportation, based on the preference of the user.

The controller may execute a third process for grouping destinations of the first users and for assigning the vehicles to each group, as the predetermined process.
By having a plurality of users get on one vehicle, the number of needed vehicles can be reduced. For example, the grouping may be performed, such that a plurality of users having close destinations and departure times get on the same vehicle.

Furthermore, the controller may decide a priority in the assignment of the vehicles for each of the first users.

For example, by assigning vehicles just to users having a higher priority than a predetermined value, it is possible to resolve the shortage of the vehicles. The priority may be decided, for example, based on a degree of usefulness by the user using the vehicle, or based on a probability that the user receiving a proposal to dispatch the vehicle to the user accepts the proposal. That is, vehicles may be preferentially assigned to users who benefit from assigning vehicles more.

The controller may decide the priority based on a usage history of the vehicles by each of the users.
For example, users who have used the vehicles in the past are expected to have a higher utilization rate, and thus the users may have a relatively high priority.

The controller may further decide the priority based on an amount of package associated with each of the users.
For example, when the amount of package carried by a user is large, it is desirable to dispatch a vehicle to the user. The amount of package carried by the user may be determined based on an image obtained by photographing the user, or may be determined based on a history of payments made by the user.

The controller may give an incentive to a user to whom a decision is made that the vehicle is not to be dispatched.
The incentive may be possible to use for the alternative means of transportation.
By giving the incentive (particularly for using the alternative means of transportation) to the user who has not been assigned a vehicle, the movement of the user can be promoted.

Hereinafter, embodiments of the present disclosure will be described with reference to the drawings. The configurations of the following embodiments are examples, and the present disclosure is not limited to the configurations of the embodiments.

### First Embodiment

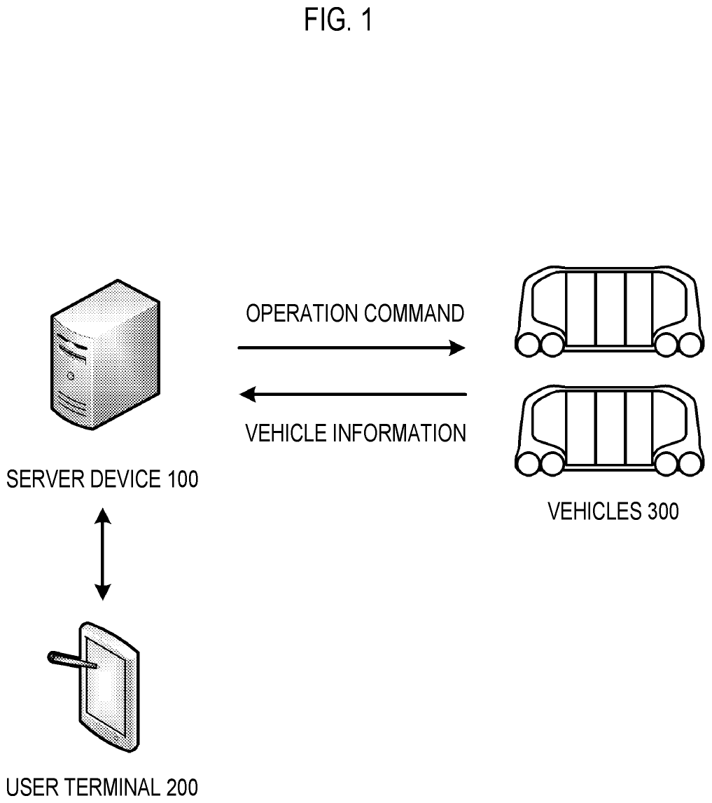

The outline of a vehicle allocation system according to a first embodiment will be described with reference to FIG. 1. The vehicle allocation system according to the present embodiment may include a user terminal 200, which is a terminal owned by a user, autonomous travelling vehicles 300 (hereinafter, referred to as vehicles 300) for providing a transportation service, and a server device 100 that controls the vehicles 300.

The user terminal 200 is a mobile terminal owned by the user. The user terminal 200 periodically transmits data related to the behavior of the user to the server device 100. In the present embodiment, the user terminal 200 transmits data representing the position of the own terminal as the data related to the behavior of the user.

The vehicles 300 are autonomous vehicles for providing a transportation service to the user. The vehicles 300 can travel unmanned according to a command transmitted from the server device 100. In addition, the vehicles 300 can allow the user to get on and off in the middle of a route. In the system, a plurality of the vehicles 300 may be provided.

The server device 100 is a device that controls the vehicles 300. The server device 100 estimates that the user will start moving in the near future (in other words, detects a sign of movement) based on position information received from the user terminal 200, and dispatches the vehicle 300 to the user based on the estimation result. In this way, it is possible to autonomously provide the means of transportation to the user who needs something to ride for movement.

On the other hand, since the number of vehicles 300 under the management of the system is limited, it is conceivable that there will be a shortage of the vehicles when many users show signs of movement at the same time. In such a case, the server device 100 assigns the vehicles 300 after taking measures to resolve the shortage of the vehicles.

In the present embodiment, an example is illustrated that the server device 100 detects a sign that a user in a predetermined commercial facility will return home and dispatches the vehicle 300 to the user in accordance with a predicted departure time.

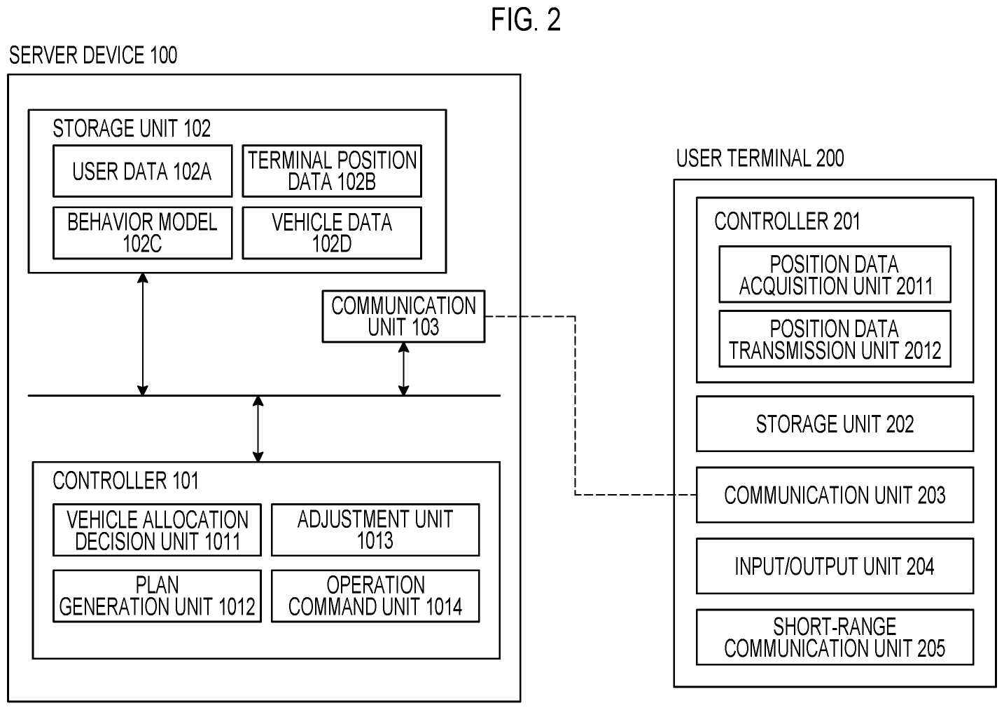

FIG. 2 is a block diagram illustrating in more detail the components of the vehicle allocation system according to the present embodiment.
First, the user terminal 200 will be described.
The user terminal 200 is a small computer, such as a smartphone, a mobile phone, a tablet computer, a personal digital assistant, a notebook computer, or a wearable computer (smartwatch, or the like). The user terminal 200 may include a controller 201, a storage unit 202, a communication unit 203, an input/output unit 204, and a short-range communication unit 205.
The controller 201 is an arithmetic unit that is in charge of the control performed by the user terminal 200. The controller 201 can be implemented by an arithmetic processing unit such as a central processing unit (CPU).

The controller 201 includes two functional modules, that is, a position data acquisition unit 2011 and a position data transmission unit 2012. The functional modules may be performed by executing a program stored in the storage unit 202, which will be described later, by the CPU.

The position data acquisition unit 2011 acquires data related to the position of the own terminal (hereinafter, referred to as position data). The position data may be represented by, for example, latitude and longitude, but in the present embodiment, it is assumed that the position data represents a position in a target commercial facility.
For example, when a plurality of beacons are installed in a commercial facility, the position data acquisition unit 2011 can communicate with the beacon via the short-range communication unit 205, which will be described later, and acquire an identifier thereof. In this case, the identifier of the beacon is the data related to the position of the own terminal. In this way, the system can grasp the place (for example, store) where the user is located.

The position data transmission unit 2012 periodically transmits the position data acquired by the position data acquisition unit 2011 to the server device 100.

The storage unit 202 may include a main storage device and an auxiliary storage device. The main storage device is a memory in which a program executed by the controller 201 and data used by the control program are developed. The auxiliary storage device is a device in which a program executed by the controller 201 and data used by the control program are stored. The auxiliary storage device may store a package of a program executed by the controller 201 as an application. Furthermore, the auxiliary storage device may also store the operating system for executing the application. When the program stored in the auxiliary storage device is loaded into the main storage device and executed by the controller 201, processes described below are executed.

The main storage device may include a random access memory (RAM) and a read-only memory (ROM). Further, the auxiliary storage device may include an erasable programmable ROM (EPROM) and a hard disk drive (HDD). Furthermore, the auxiliary storage device may include removable medium, that is, a portable recording medium. The removable medium is, for example, a universal serial bus (USB) memory or a disc recording medium, such as a compact disc (CD) or a digital versatile disc (DVD).

The communication unit 203 is a wireless communication interface for connecting the user terminal 200 to a network. The communication unit 203 may communicate with the server device 100 via, for example, a wireless LAN or a mobile communication service, such as 3G, LTE, or 5G.
The input/output unit 204 is a unit that receives an input operation performed by the user and presents information to the user. In the present embodiment, as the input/output unit 204, one touch panel display may be used. That is, the input/output unit 204 may be a liquid crystal display and control means thereof, and a touch panel and control means thereof.

The short-range communication unit 205 is an interface for performing short-range wireless communication with a beacon installed in the facility. The short-range communication unit 205 uses a predetermined wireless communication standard to perform communication at a short distance (approximately several meters).
In the present embodiment, the short-range communication unit 205 performs data communication according to the Bluetooth (registered trademark) Low Energy standard (hereinafter referred to as BLE). Although BLE is illustrated in the present embodiment, other wireless communication standards can also be used. For example, near field communication (NFC), ultra wideband (UWB), Wi-Fi (registered trademark) and the like, can also be used.

Next, the server device 100 will be described.
The server device 100 stores a model (hereinafter referred to as a behavior model) representing a typical behavior that a user can take, and determines whether or not the user who owns the user terminal 200 shows a sign of returning home based on the position data received from the user terminal 200.
Furthermore, the server device 100 assigns the vehicle 300 for the user who has shown the sign of returning home in a predetermined period of time to get the user on the vehicle. When the vehicle 300 is insufficient as a result of the assignment, the following two processes are used together to try to resolve the shortage of the vehicles.
(1) Proposing the alternative means of transportation to a user who can return home without using the vehicles 300
(2) Delaying the vehicle allocation time (departure time from the commercial facility) for each of the users.
A specific method will be described later.

The server device 100 can be constituted by a general-purpose computer. That is, the server device 100 can be constituted by a computer having a processor, such as a CPU or GPU, a main storage device, such as RAM or ROM, and an auxiliary storage device, such as EPROM, a hard disk drive, or removable medium. The removable medium may be, for example, a USB memory or a disc recording medium, such as a CD or DVD. The operating system (OS), various programs, various tables, or the like are stored in the auxiliary storage device, the programs stored therein are loaded into the work area of the main storage device and executed, and each of component parts or the like is controlled through the execution of the programs, thereby making it possible to implement each function that meets a predetermined purpose, as will be described later. Note that some or all of the functions may be implemented by hardware circuits such as, ASICs and FPGAs.

The controller 101 is an arithmetic unit that is in charge of the control performed by the server device 100. The controller 101 can be constructed by an arithmetic processing unit, such as a CPU.
The controller 101 includes four functional modules, that is, a vehicle allocation decision unit 1011, a plan generation unit 1012, an adjustment unit 1013, and an operation command unit 1014. Each functional module may be performed by the CPU executing the stored program.

The vehicle allocation decision unit 1011 acquires the position data from the user terminal 200, and determines that the user shows a sign of returning home based on acquired position data. The determination can be made by using the position data stored in a storage unit 102, which will be described later, and the behavior model corresponding to each of the users.
The vehicle allocation decision unit 1011 transfers the information about the user from whom the sign of returning home is detected in a predetermined period of time to the plan generation unit 1012.

The plan generation unit 1012 generates an operation schedule (hereinafter referred to as a vehicle allocation plan) for a plurality of vehicles 300 based on the information acquired from the vehicle allocation decision unit 1011.
Further, the plan generation unit 1012 has a function of managing the vehicles 300 included in the system. The plan generation unit 1012 periodically communicates with the vehicles 300 included in the system to acquire a current position and status, a task currently being executed, an occupied time, and the like, of each vehicle and store the above data as vehicle data. By referring to the stored vehicle data, it is possible to decide the vehicle to be dispatched to a specific user.

When the vehicles 300 are insufficient in the process of generating the vehicle allocation plan, the adjustment unit 1013 executes the processes ((1) and (2) described above) for resolving the shortage. When the shortage of the vehicles is resolved, the fixed vehicle allocation plan is transmitted to the operation command unit 1014.

The operation command unit 1014 generates a command (operation command) for transporting the user based on the received vehicle allocation plan. The operation command includes information on a travel route, a point at which the user gets on and off, an identifier of the user who gets on and off, and the like.

The storage unit 102 may include a main storage device and an auxiliary storage device. The main storage device is a memory in which a program executed by the controller 101 and data used by the control program are developed. The auxiliary storage device is a device in which a program executed by the controller 101 and data used by the control program are stored.

The storage unit 102 stores information (user data 102A) about a user using the system. The user data includes information, contact information, a telephone number, and the like for specifying the user terminal 200 owned by each of the users.

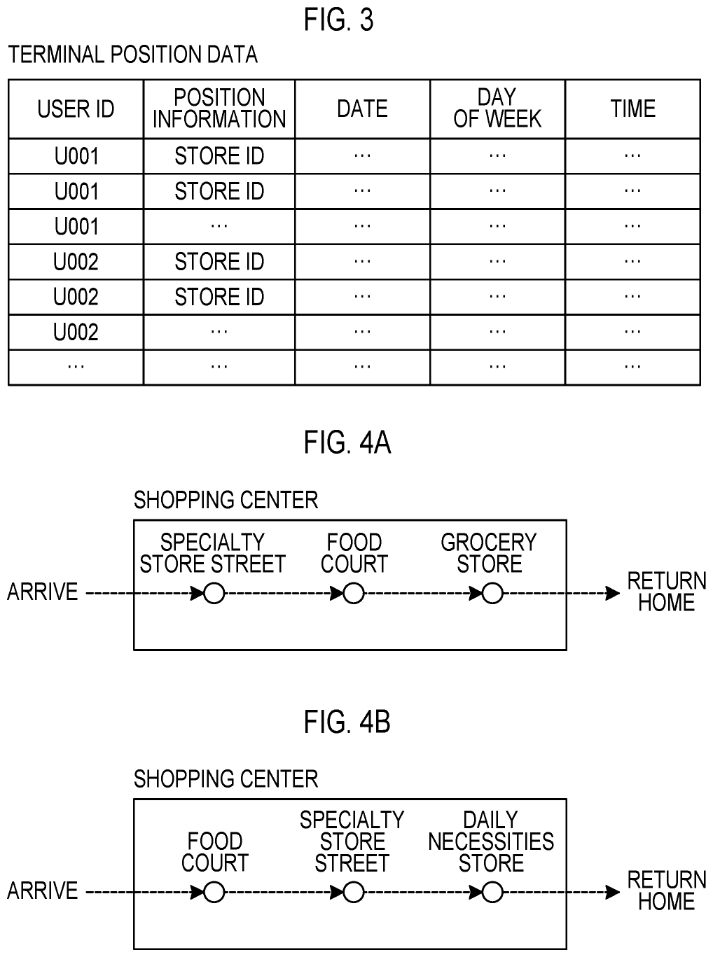

Furthermore, the storage unit 102 stores the position data periodically collected from the user terminal 200 as terminal position data 102B. FIG. 3 is an example of the terminal position data. As illustrated, the terminal position data includes information such as a user identifier (user ID), position information (store ID), date, day of the week, and time.

In addition, the storage unit 102 stores a behavior model (behavior model 102C) for each of the users. The behavior model in the present embodiment is a model in which the behavior that the user can take before the user starts to return home is defined by the transition of the position.
For example, as illustrated in FIGS. 4A and 4B, typical behaviors from a store visit to a store exit in a commercial facility may differ from user to user. For example, when there is a user who takes the behavior pattern as illustrated in FIG. 4A and the user moves to a grocery store, it can be estimated that the user will return home soon. When there is a user who takes the behavior pattern as illustrated in FIG. 4B and the user moves to a daily necessities store, it can be estimated that the user will return home soon. In the present embodiment, the behavior model stores information for estimating the timing when the user starts returning home in this manner. The behavior model corresponding to the user is stored in the storage unit 102 in advance. The behavior model can be generated, for example, based on a history of the position data acquired from the user terminal 200 owned by the user.

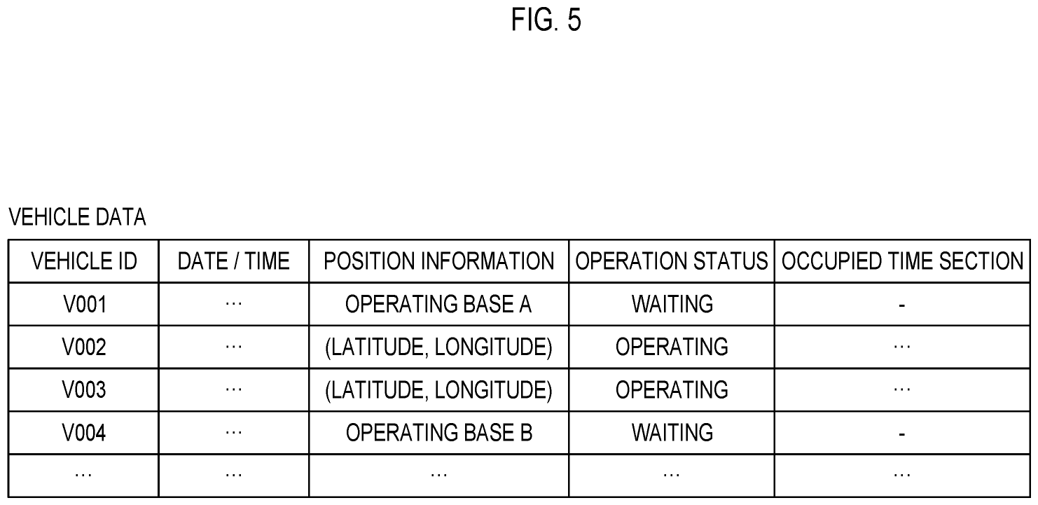

In addition, the storage unit 102 stores data (vehicle data 102D) for managing the vehicles 300. FIG. 5 is an example of the vehicle data. The vehicle data is data in which identifiers and position information, operation statuses, occupied time sections, and the like of the vehicles 300 managed by the system, are described. The vehicle data may include information other than above-mentioned items. For example, the vehicle data may include information on the use, the type and waiting points (garages and business offices) of the vehicles 300, information on a vehicle body size, load capacity (riding capacity), mileage when fully charged, current mileage, stopovers, travel routes, destinations, or the like.
The vehicle data 102D is periodically updated based on information transmitted from the vehicles 300 (hereinafter referred to as vehicle information).

The communication unit 103 is a communication interface for connecting the server device 100 to a network. The communication unit 103 includes, for example, a network interface board and a wireless communication circuit for wireless communication.

The configuration illustrated in FIG. 2 is an example, and all or part of the illustrated functions may be executed by using specially designed circuits. Furthermore, a program may be stored or executed by a combination of the main storage device and the auxiliary storage device, other than those illustrated in the figure.

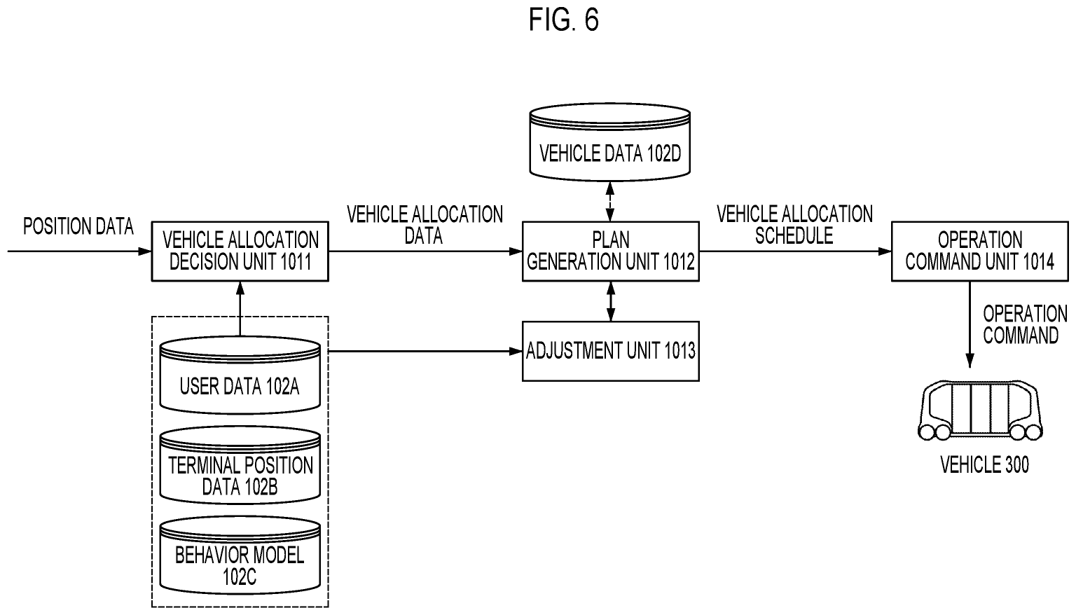

Next, the process executed by the controller 101 will be described with reference to FIG. 6, which is a diagram illustrating data transmitted and received between modules.

The vehicle allocation decision unit 1011 receives the position data from the user terminal 200, and accumulates the received position data as the terminal position data 102B in the storage unit 102. Furthermore, the vehicle allocation decision unit 1011 determines that the user shows a sign of returning home by comparing the accumulated position data with the behavior model stored in the storage unit 102. For example, when the change in position matches the pattern defined in the behavior model, it can be estimated that the user will start returning home in the near future.

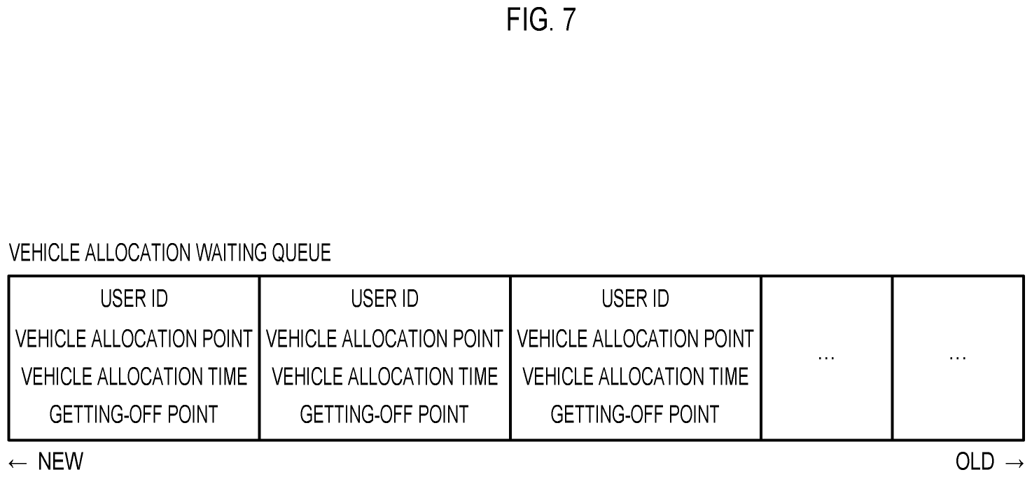

The vehicle allocation decision unit 1011 generates vehicle allocation data when determination is made that the user will start returning home in the near future. The vehicle allocation data includes data including an identifier of the user picked up by the vehicle 300, a point and time at which the user is picked up, and a point at which the user gets off.
For example, when the vehicle allocation decision unit 1011 determines that the user will start returning home after 30 minutes, the vehicle allocation data indicating that the user will be picked up at the entrance of the commercial facility 30 minutes later is generated. The vehicle allocation data is transmitted to the plan generation unit 1012 and accumulated in a vehicle allocation waiting queue as illustrated in FIG. 7.

The plan generation unit 1012 processes the vehicle allocation data stored in the vehicle allocation waiting queue every predetermined cycle, and performs scheduling on the vehicles 300. For example, when the predetermined period of time is 15 minutes, the vehicle 300 is assigned to each of the users based on the vehicle allocation data accumulated during 15 minutes.
Here, when the assignment of the vehicle 300 fails, that is, when determination is made that the vehicles are insufficient, the process is taken over by the adjustment unit 1013. When the assignment of the vehicle 300 is successful, the process is taken over by the operation command unit 1014.

Furthermore, the plan generation unit 1012 executes a process for managing the vehicles 300. That is, the process is a process for collecting information (vehicle information) on the status of each vehicle to update the vehicle data 102D, by periodically communicating with the vehicles 300.

The adjustment unit 1013 executes the above-mentioned two types of processes in order to resolve the shortage of the vehicles. That is, (1) the process for proposing the alternative means of transportation to users who can return home without using the vehicles 300, and (2) the process for delaying the vehicle allocation time for each of the users (departure time of the user).

For example, a user who has previously consented to return home by alternative means of transportation or a user who uses the vehicles 300 infrequently can be deleted from the vehicle allocation waiting queue.

Furthermore, when the shortage of vehicles is resolved by delaying the vehicle allocation time for a certain user, the start of returning home is delayed by giving an incentive to the user.
For example, when the vehicles 300 can be assigned by delaying the vehicle allocation time for a certain user by 15 minutes, the adjustment unit 1013 gives the user an incentive to stay in the commercial facility for an extra 15 minutes. The content of the incentive can include, for example, a coupon or a cash voucher possible to be used at a store in a commercial facility.

A target store is desirably decided based on the preference of the user. As a method of determining the preference of the user, for example, there are a method of using terminal position data corresponding to the user, a method of using the user data of the user, a method of using the behavior model of the user, or the like.

For example, when a specific store (or store of a specific genre) is frequently included in the history of the terminal position data corresponding to the user, determination can be made that the degree of preference for the store is high. When a specific store (or store of a specific genre) is included in the behavior model of the user, determination can be made that the degree of preference for the store is high. Furthermore, when the user data includes data representing the preference of the user, the preference can be determined based on the data.
When the user presented with the incentive consents to the change of the vehicle allocation time and the shortage of the vehicles is resolved, the process returns to the plan generation unit 1012 and the vehicle allocation schedule is fixed.

The operation command unit 1014 executes a process for commanding the operation of each of the vehicles 300 based on the fixed vehicle allocation schedule.
The operation command includes information for specifying the user, a time for picking up the user (vehicle allocation time), a point where the user gets on (vehicle allocation point), a point where the user gets off (for example, home of the user), and the like.
The vehicle 300 that has received the operation command travels in accordance with the operation command and transports the user.

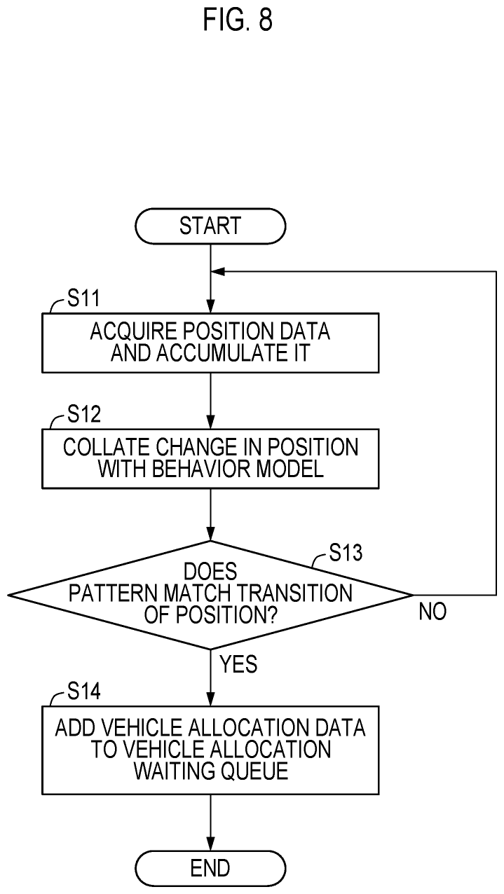

FIGS. 8 to 10 are flowcharts showing the processes executed by the server device 100. The flowchart shown in FIG. 8 shows a process in which the vehicle allocation decision unit 1011 receives and accumulates the position data from the user terminal 200.
The process for collecting vehicle information and updating the vehicle data 102D by the plan generation unit 1012 is executed in parallel independently of the illustrated process.

In step S11, the vehicle allocation decision unit 1011 receives the position data from the user terminal 200 and accumulates it in the storage unit 102.

Next, in step S12, the vehicle allocation decision unit 1011 collates a set of the accumulated position data with the behavior model corresponding to the user, and determines whether or not there is a user showing a sign of returning home (step S13).

For example, when a matching degree of the transition of the position to a predetermined movement pattern exceeds a threshold value, determination can be made that the sign of returning home is seen. When the transition matches the pattern, the process proceeds to step S14.

In step S14, the vehicle allocation decision unit 1011 generates vehicle allocation data corresponding to the user, and adds the vehicle allocation data to the vehicle allocation waiting queue.

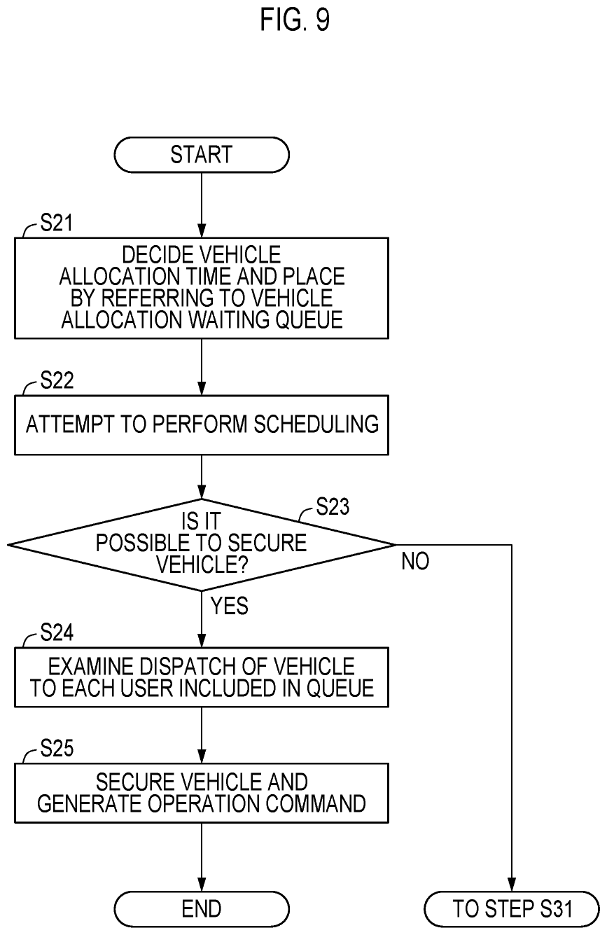

The flowchart shown in FIG. 9 shows a process for assigning the vehicles 300.
First, in step S21, the plan generation unit 1012 acquires a vehicle allocation time, a vehicle allocation point, and a getting-off point corresponding to each of the users by referring to the vehicle allocation waiting queue.
Next, in step S22, the plan generation unit 1012 attempts to perform scheduling on the vehicles 300. Specifically, with reference to the vehicle data 102D, the plan generation unit 1012 generates a schedule for operating the vehicles 300 depending on multiple vehicle allocation data.
Here, when scheduling is not possible (No in step S23), that is, when the vehicles 300 are insufficient, the process proceeds to step S31.

When scheduling is possible (Yes in step S23), the process proceeds to step S24, and the plan generation unit 1012 examines the dispatch of the vehicles to each of the users included in the queue. Specifically, the plan generation unit 1012 notifies the user terminal 200 that the vehicle can be dispatched, and acquires a response from the user. Then, the plan generation unit 1012 fixes the operation schedule based on the response.
The fixed operation schedule is transmitted to the operation command unit 1014.

In step S25, the operation command unit 1014 generates an operation command for each vehicle included in the operation schedule. The operation command is transmitted to each corresponding vehicle 300, and the operation is started.

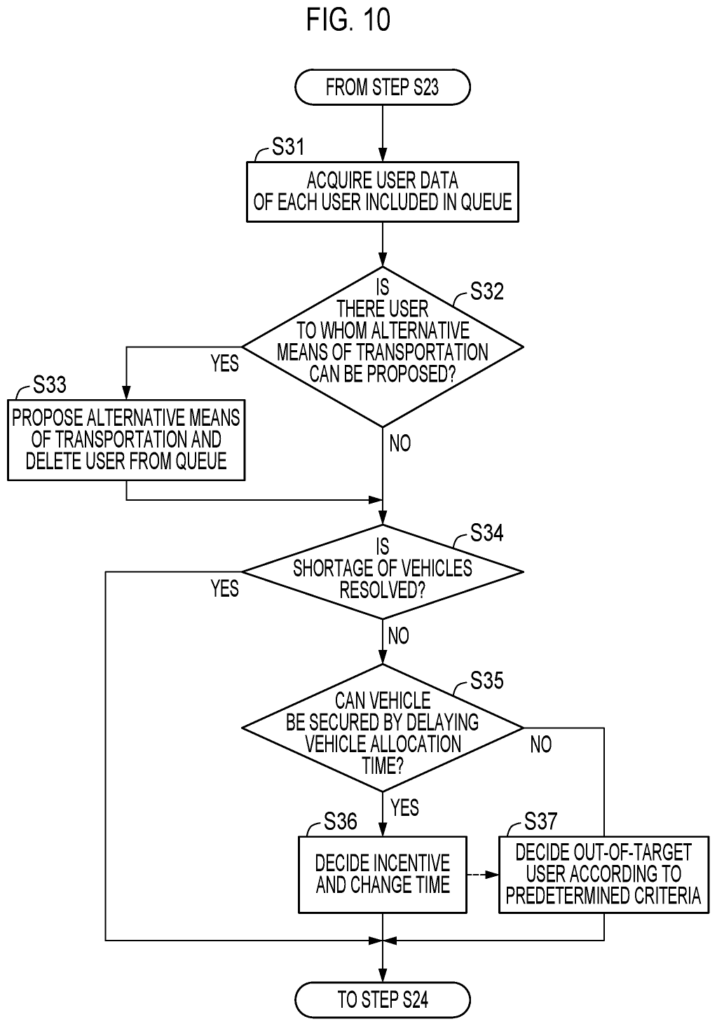

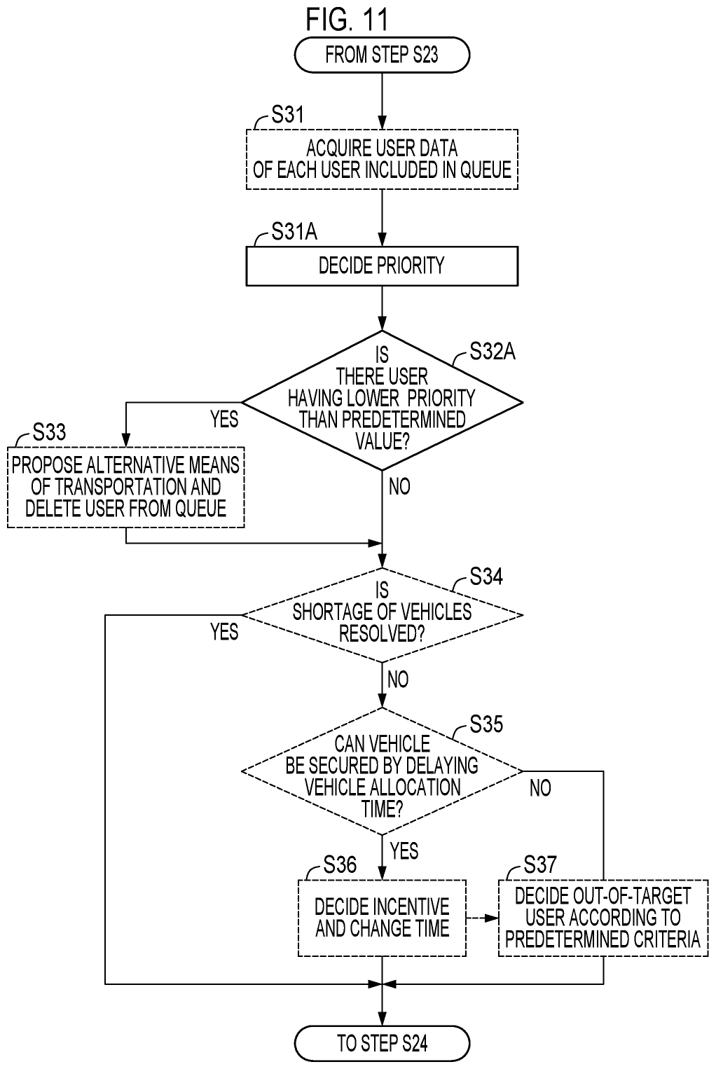

FIG. 10 is a flowchart showing a process for resolving the shortage of the vehicles.
First, in step S31, the adjustment unit 1013 acquires user data corresponding to each of the users included in the vehicle allocation waiting queue.

Next, in step S32, the adjustment unit 1013 determines whether or not there is a user to whom the alternative means of transportation can be proposed. The determination as to whether or not it is possible to propose the alternative means of transportation can be made based on, for example, the preference of the user.
For example, when the user data includes information indicating the degree of preference for the use of the vehicle 300 and indicating whether or not the use of the alternative means of transportation is acceptable, it is possible to decide whether or not the alternative means of transportation can be proposed based on the information. When there is a user to whom the alternative means of transportation can be proposed, the determination in the step is positive.
When a positive determination is made in the step, the process proceeds to step S33. When a negative determination is made in the step, the process proceeds to step S34.

In step S33, the adjustment unit 1013 transmits data for proposing the use of the alternative means of transportation to the user terminal 200 of the user. The user is deleted from the vehicle allocation waiting queue. An incentive may be given to the user to whom the use of the alternative means of transportation is proposed. The incentive may, for example, covers costs (transportation costs, or the like) incurred by using alternative means of transportation. For example, a boarding coupon possible to be used for the alternative means of transportation may be issued.

In step S34, the adjustment unit 1013 determines whether or not the shortage of the vehicles is resolved. Here, when the shortage is not resolved, the process proceeds to step S35. When the shortage is resolved, the process proceeds to step S24 described above.

In step S35, for any of the users included in the vehicle allocation waiting queue, an attempt to find out whether or not the shortage of the vehicles can be resolved by delaying the vehicle allocation time is made. In the step, for example, the schedule may be regenerated by a method for minimizing the total delay time of all users, or the schedule may be regenerated by a method for minimizing the number of users who delay the vehicle allocation time. Any method can be employed for regenerating the schedule.
When a positive determination is made in the step, the process proceeds to step S36.

In step S36, the adjustment unit 1013 decides the incentive to be given to the user for whom the vehicle allocation time is to be changed. In the present embodiment, as the incentive, a coupon possible to be used at a store in a commercial facility is given. As described above, a target store can be decided based on the preference and the history of movement of the target user (store visit history that can be determined from the position data).

The incentive may be given with consent of the user. For example, a message stating “If you consent to delay the vehicle allocation time, a coupon will be given” may be transmitted to the user terminal 200, and the coupon may be given based on the consent of the user. When the user consents, the vehicle allocation time for the user is changed, and the process proceeds to step S24.

When a negative determination is made in step S35, it means that the vehicles 300 cannot be dispatched to all users. Further, in step S36, there may be a case where a user who does not consent to change the vehicle allocation time, and the shortage of the vehicles is not resolved.
In this case, in step S37, an out-of-target user is decided. In the step, the users selected by a predetermined criterion are deleted from the vehicle allocation waiting queue until the shortage of the vehicles is resolved. In this case, a notification indicating that the vehicle 300 has not been assigned may be transmitted to the users selected as described above.

As described above, the server device 100 according to the first embodiment detects a sign that the user will start moving (returning home) based on the information received from the user terminal 200, and autonomously arranges the vehicles. In addition, when the shortage of the vehicles is expected, an adjustment process is executed to resolve the shortage. With such a configuration, it is possible to make adjustments at a stage before examining the dispatch of the vehicles to a user, thereby making it possible to improve the convenience of the user.

Furthermore, in the adjustment process, measures for resolving the shortage of the vehicles is decided for each of the users based on the information related to each of the users. This makes it possible to propose measures that are easily accepted by each of the users.

### Second Embodiment

In the first embodiment, in step S32, the determination as to whether or not the alternative means of transportation can be proposed, is made, and the vehicles 300 are assigned just to the users to whom the alternative means of transportation cannot be proposed.

In contrast, a second embodiment is an embodiment in which a priority for vehicle assignment is decided for each of the users, and a user having a priority higher than a predetermined value is targeted for assignment.

FIG. 11 is a flowchart of a process executed by the server device 100 in the second embodiment. Since the steps shown by the dotted lines are the same as those in the first embodiment, detailed description thereof will not be repeated.

In the second embodiment, in step S31A, the priority for each of the users is decided. The priority can be set, for example, to a value indicating the degree of usefulness when the user uses the vehicle 300. The priority can be, for example, the following values.
(1) A value indicating the number of times of use or frequency of use of the vehicles 300 by the user in the past
For example, information indicating the usage history of the vehicles 300 is recorded in the user data, and a value indicating the number of times of use or the frequency of use in a predetermined period of time in the past is set as the priority.
(2) A value indicating the number of times or frequency of user responses to vehicle allocation proposals in the past
For example, information indicating the number of times the user receiving the proposal to dispatch the vehicle 300 to the user responds to the proposal, a response probability, the number of times the proposal is accepted, an acceptance probability, a round trip time until response, and the like, is recorded in the user data, and a value indicating the above items is set as the priority. That is, a higher priority is assigned to a user who intends to use the vehicles 300 more positively.
A value other than what has been stated above may be used as the priority.

Furthermore, the priority may be corrected according to the state of the user. For example, the greater the amount of package carried by the user, the higher the priority may be set, or the greater the number of people (family members, or the like) moving with the user, the higher the priority may be set. The amount of package carried by the user may be determined based on a result of sensing the user, or may be determined based on payment information or the like associated with the user. The number of people moving with the user may be acquired via the means of transportation on an outbound route. For example, when the user uses the vehicle 300 on the outbound route, the number of people moving with the user can be determined based on the number of passengers at that time.

Then, in step S32A, determination is made whether or not there is a user having a lower priority than the predetermined value, and when the determination is affirmative, the alternative means of transportation is proposed to the user. As described above, in the second embodiment, the vehicles are preferentially assigned to the users who are determined to more benefit from using the vehicles. With such a configuration, it is possible to further optimize the transportation efficiency by the system.

### Modification Example

The above embodiments are merely examples, and the present disclosure may be appropriately modified and implemented without departing from the spirit of the present disclosure.
For example, the processes and means described in the present disclosure can be freely combined and carried out as long as technical conflict arises.

Further, in the description of the embodiments, the sign that the user staying in the commercial facility returns home is detected; however, when it can be estimated that the user starts moving, the place of stay of the user is not limited to the commercial facility, and the behavior of the target is not limited to returning home.

in the description of the embodiments, the process for delaying the vehicle allocation time is executed in steps S35 to S36; however, when the shortage of the vehicles can be resolved by advancing the vehicle allocation time, the process for advancing the vehicle allocation time may be executed. For example, by giving an incentive to the user, the start of returning home may be advanced.
Furthermore, when the shortage of the vehicles can be resolved by having a plurality of users ride together, the process for grouping the users based on the destinations of the users and assigning the vehicles to each group may be additionally executed.

Furthermore, in the description of the embodiments, it is estimated that the user starts moving based on the position information of his or her user terminal 200; however, other data may be used. For example, determination may be made that the user will start moving in the near future, based on information other than the position information transmitted from the user terminal 200 owned by the user (for example, information on electronic payment), or data obtained by sensing the user.

The process described as being performed by one device may be shared and executed by a plurality of devices. Alternatively, the process described as being performed by different devices may be executed by one device. In a computer system, it is possible to flexibly change what kind of hardware configuration (server configuration) is used to implement each function.

The present disclosure can also be implemented by supplying a computer program having the functions described in the above-described embodiments to a computer, and causing one or more processors of the computer to read and execute the program.

The above-mentioned computer program may be provided to the computer by a non-transitory computer-readable storage medium that can be connected to a system bus of the computer, or may be provided to the computer via a network. Examples of the non-transitory computer-readable storage media include any type of disc, such as a magnetic disc (floppy (registered trademark) disc, hard disk drive (HDD), or the like), optical disc (CD-ROM, DVD, Blu-ray disc, or the like), read-only memory (ROM), random access memory (RAM), EPROM, EEPROM, magnetic cards, flash memory, optical cards, and any type of medium suitable for storing electronic instructions.

What is claimed is:

1. An information processing device that manages a plurality of vehicles, the information processing device comprising:
a controller configured to execute operations including:
specifying a first user estimated to start moving within a predetermined period of time from among a plurality of users based on a result of sensing the users; and
generating a schedule for dispatching a vehicle under management to the first user, wherein
the controller is configured to execute a predetermined process for resolving a shortage of the vehicles when the number of vehicles under the management is insufficient as a result of assigning the vehicles to a plurality of the first users.

2. The information processing device according to claim 1, wherein the controller is configured to execute a first process for changing a start time of movement for at least one of the first users when the shortage of the vehicles is resolved by changing the start time of movement for the first user, as the predetermined process.

3. The information processing device according to claim 2, wherein the controller is configured to execute a first process for delaying a start of movement by a predetermined time for at least one of the first users when the shortage of the vehicles is resolved by delaying the start of movement by the predetermined time for the first user, as the predetermined process.

4. The information processing device according to claim 3, wherein the controller is configured to delay the start of movement by giving the first user staying in a commercial facility an incentive possible to be used at a store to allow the first user to use the store.

5. The information processing device according to claim 4, wherein the controller is configured to decide the store based on a preference of the first user.

6. The information processing device according to claim 1, wherein the controller is configured to execute a second process for providing alternative means of transportation to at least one of the first users as the predetermined process.

7. The information processing device according to claim 1, wherein the controller is configured to decide whether to execute a first process for delaying a start of movement by a predetermined time or to execute a second process for providing alternative means of transportation, for each of the first users, based on a preference of the first user, as the predetermined process.

8. The information processing device according to claim 1, wherein the controller is configured to execute a third process for grouping destinations of the first users and assigning the vehicles to each group, as the predetermined process.

9. The information processing device according to claim 1, wherein the controller is configured to decide a priority in the assignment of the vehicles for each of the first users.

10. The information processing device according to claim 9, wherein the controller is configured to decide the priority based on a usage history of the vehicles by each of the users.

11. The information processing device according to claim 10, wherein the controller is further configured to decide the priority based on an amount of package associated with each of the users.

12. The information processing device according to claim 9, wherein the controller is configured to assign the vehicles just to users with a higher priority than a predetermined value.

13. The information processing device according to claim 12, wherein the controller is configured to give an incentive to a user to whom a decision is made that the vehicle is not to be dispatched.

14. The information processing device according to claim 13, wherein the incentive is possible to be used for alternative means of transportation.

15. An information processing method that is executed by an information processing device that manages a plurality of vehicles, the information processing method comprising:
specifying a first user estimated to start moving within a predetermined period of time from among a plurality of users based on a result of sensing the users;
generating a schedule for dispatching a vehicle under management to the first user;
determining whether or not there is a shortage of the vehicles under the management as a result of assigning the vehicles to a plurality of the first users; and
executing a predetermined process for resolving the shortage of the vehicles when there is the shortage of the vehicles.

16. The information processing method according to claim 15, wherein the executing of the predetermined process includes executing a first process for delaying a start of movement by a predetermined time for at least one of the first users when the shortage of the vehicles is resolved by delaying the start of movement by the predetermined time for the first user.

17. The information processing method according to claim 16, wherein the start of movement is delayed by giving the first user staying in a commercial facility an incentive possible to be used at a store to allow the first user to use the store.

18. The information processing method according to claim 15, wherein a priority is decided in the assignment of the vehicles for each of the first users.

19. The information processing method according to claim 18, wherein the priority is decided based on a usage history of the vehicles by each of the users.

20. A program that causes a computer to execute the information processing method according to claim 15.
